(19) United States
(12) Patent Application Publication
(10) Pub. No.: US 2023/0266019 A1
(43) Pub. Date: Aug. 24, 2023

(54) A HEATING SYSTEM

(71) Applicant: ACTIONZERO ESCOPOD LIMITED, Cork (IE)

(72) Inventors: Liam FLYNN, County Cork (IE); John O'LEARY, County Kerry (IE)

(73) Assignee: ACTIONZERO ESCOPOD LIMITED, Cork (IE)

(21) Appl. No.: 18/017,973

(22) PCT Filed: Jul. 16, 2021
(86) PCT No.: PCT/EP2021/070024

§ 371 Date: Jan. 25, 2023

(30) Foreign Application Priority Data
Jul. 29, 2020 (EP) 20188397.2

(51) Int. Cl. F24D 17/00; F24D 17/02; F24D 3/18; F24H 4/02

(52) U.S. Cl. CPC F24D 17/0005; F24D 17/02; F24D 3/18; F24H 4/02; F24D 2200/12; F24D 2200/18; F24D 2220/042; F24D 2220/06

(57) ABSTRACT

A heating system (1) has a turbine (20) for burning a fuel to provide flue gas and electrical energy. A flue gas heat exchanger (25) receives the flue gas and uses it to heat water in three of stages. An air conduit (2) receives inlet air (3) and gases from secondary inlets (5, 26) from within the system to elevate the temperature in the main conduit (2) above ambient. An evaporator (8) recovering heat from the air flow of the main conduit, and provides energy via an evaporator coil to an air source heat pump ASHP (50). A water source heat pump WSHP (60) receives a water feed at an elevated temperature from the ASHP (50), and it cools the flue gas in a third heat exchanger stage (25(c)). Hence, WSW efficiency is high and it provides product water, as do the first and second stages of the flue gas heat exchanger (25)

The present invention relates to water heating systems.

Heat pump technology is well known, and its limitations are also well known. Temperature of water delivered, with acceptable efficiencies, is too low for many buildings, the typical requirements being in the region of 60° C. to 75° C. To operate an air source heat pump (ASHP) in an existing building considerable refurbishment is often required, and there are inherent inefficiencies at low ambient temperature when most heating is required resulting in demand for extra electrical power from the grid. Commercial natural gas is typically about 3.5 times less expensive per kWh than electrical energy.

The invention is directed towards achieving improved efficiency in water heating systems.

### SUMMARY OF THE DISCLOSURE

The invention provides a heating system as set out in claim 1 and the dependent claims 2 to 18. It also provides a method of operation of such as system as set out in claim 16 and the dependent claims 19 to 35.

We describe a heating system comprising:
a turbine for burning a fuel to provide flue gas and electrical energy,
a flue gas heat exchanger for receiving the flue gas and using the flue gas to heat water,
an air conduit for receiving inlet air and gases from secondary inlets from within the system to elevate the temperature in the main conduit above ambient,
an air heat exchanger for recovering heat from the air flow of the main conduit, and
an air source heat pump ASHP to receive energy from the air heat exchanger.

Preferably, the system further comprises a water source heat pump WSHP to receive a water feed at an elevated temperature from the ASHP, in which at least one stage of the heat exchanger and the WSHP provide process hot water.

Preferably, the flue gas heat exchanger heats water in a plurality of stage to provide a plurality of hot water process water outlets. Preferably, the air heat exchanger comprises a cooler arranged to cool air from the main conduit for venting to atmosphere.

Preferably, the cooler shares an evaporator coil with the ASHP to transfer energy to said ASHP.

Preferably, the system further comprises a water source heat pump WSHP to receive a water feed at an elevated temperature from the ASHP, in which at least one stage of the heat exchanger and the WSHP provide process hot water, and wherein recovered energy from the flue gas heat exchanger is provided to the.

Preferably, the cooler and the ASHP are in an evaporator circuit, whereby the cooler delivers energy to the ASHP, the ASHP receives elevated-temperature water from the flue gas heat exchanger and delivers elevated temperature water to the WSHP, and the flue gas heat exchanger delivers elevated-temperature water to the WSHP.

Preferably, a main conduit secondary inlet is adapted to provide heated air from control circuits of the turbine. Preferably, a main conduit secondary inlet is adapted to provide residual flue gas from the flue gas heat exchanger. Preferably, the secondary inlets are arranged to provide the turbine control circuit heated air upstream of the residual flue gas.

Preferably, at least one stage of the heat exchanger comprises a plurality of circuits with the stage inlet flow being split for pressure reduction. Preferably, the WSHP provides process hot water as a product.

Preferably, the system is adapted to recover latent heat energy without creating excessive back pressure on the turbine, while recovering energy to do useful work, thus avoiding deterioration of the electrical efficiency of the turbine.

Preferably, the system is adapted to provide condensation of water vapour in the flue gas in the flue gas heat exchanger by the WSHP cooling the flue gas and extracting latent energy to increase the efficiency of the WSHP, the water vapour in the flue gas including the products of combustion and water vapour in incoming ambient air for combustion.

Preferably, the turbine uses a high air to fuel ratio, in excess of 30% air by weight, preferably in excess of 50%, resulting in a high proportion of water vapour, yielding a large amount of available heat from subsequent condensation.

### DETAILED DESCRIPTION OF THE INVENTION

The invention will be more clearly understood from the following description of some embodiments thereof, given by way of example only with reference to the accompanying drawings in which:

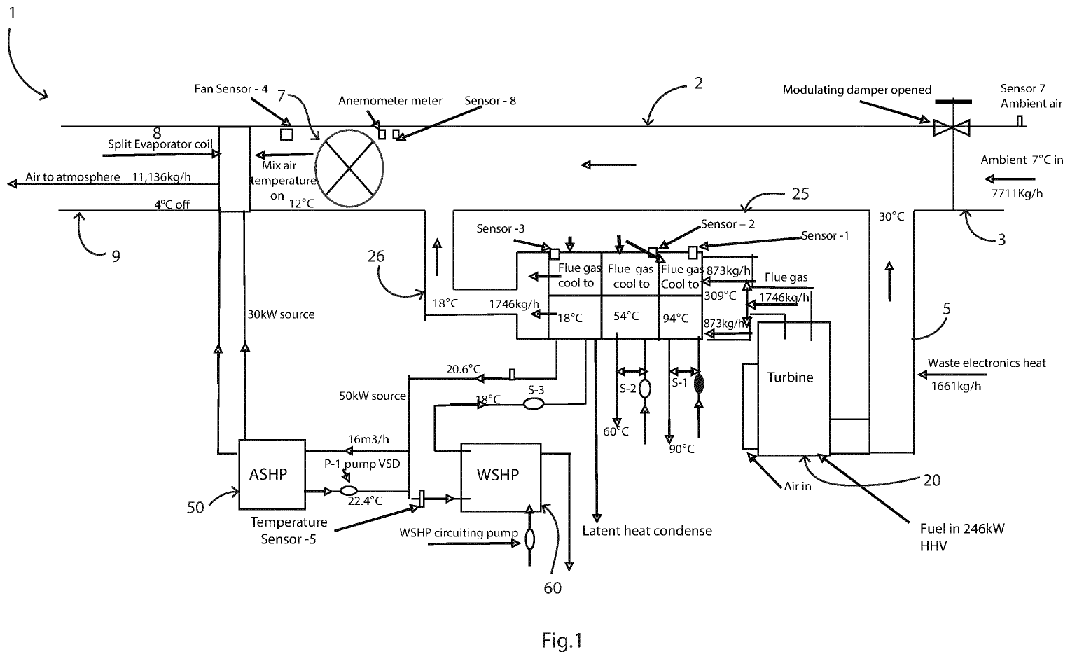

FIG. 1 is a diagram of a heating system;

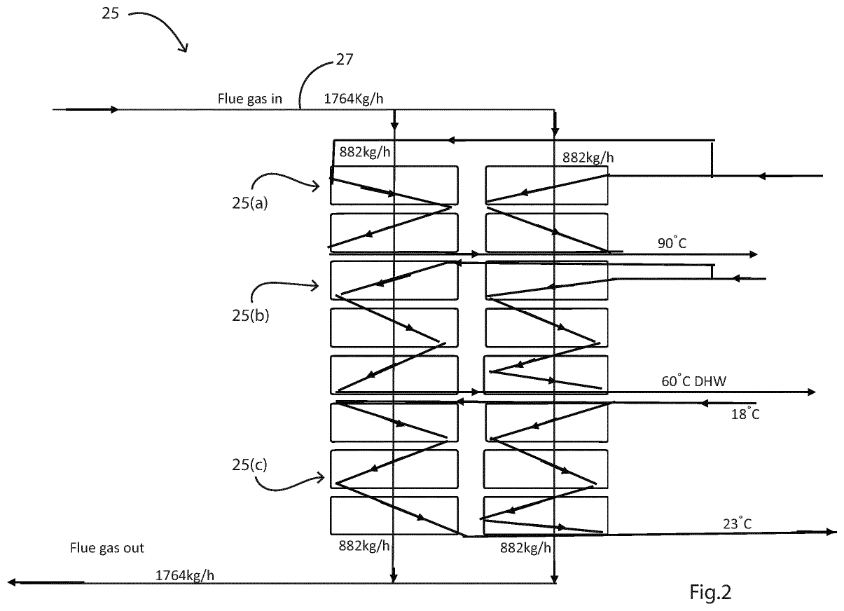

FIG. 2 is a diagram illustrating a three-stage heat recovery apparatus for a turbine; and

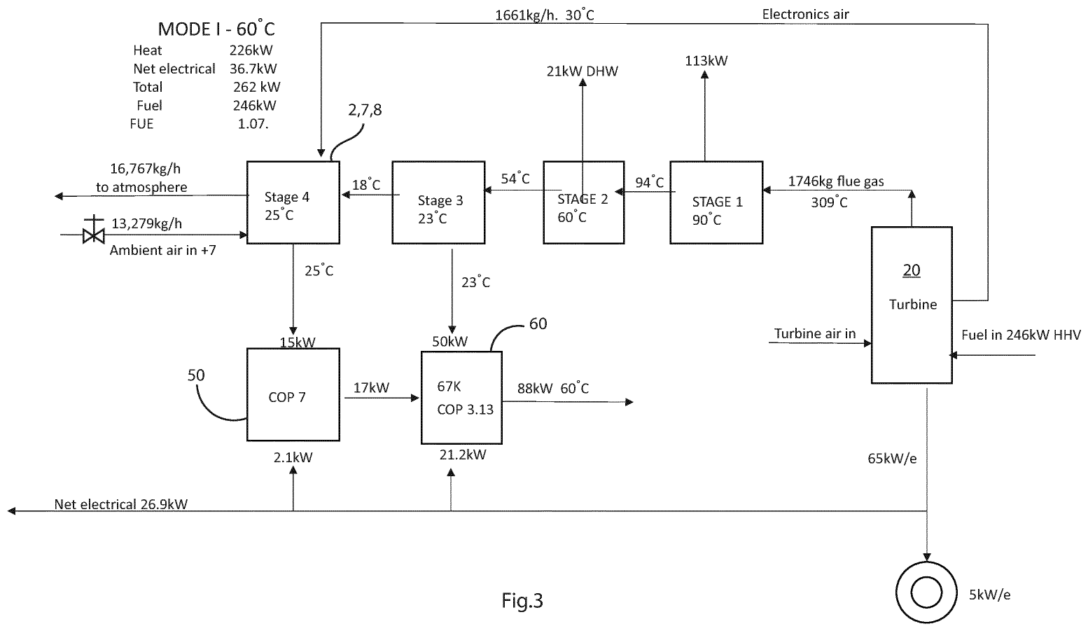

FIGS. 3 to 8 are flow diagrams illustrating operation of the system.

Referring to FIGS. 1 and 2 a heating system 1 comprises a main air flow conduit or “duct” 2 with an inlet 3 to take in ambient air from outside, and internal first and second secondary inlets 5 and 26 to take in hot air from within the system 1, a variable speed drive (VSD) fan 7, and an evaporator coil cooler 8 to extract energy from the combined air flow.

A turbine 20 is arranged to receive gas fuel and provide hot exhaust gas to a three-stage heat exchanger 25, each stage of which can provide heated air or water at a desired temperature, progressively lower from the first stage to the third stage. The main conduit 2, the fan 7, and the outlet cooler 8 may be regarded as a fourth stage of heat exchange downstream of the heat exchanger's three stages. The turbine also provides electrical power to heat-pumps, in this case an air source heat pump ASHP 50 and a water source heat pump WSHP 60. The heat pump 50 receives air at a temperature which is elevated above the outside ambient. Also, the ASHP 50, using elevated-temperature inlet air, delivers elevated-temperature water to the WSHP 60.

The first and second stages 25(a) and 25(b) of the heat exchanger 25 provide hot water as system outputs. The third stage 25(c) provides hot water as a source to the WSHP 60 by extracting sensible and latent heat from the lower temperature exhaust gas.

For example, FIG. 1 gives indicative parameter values which are set out in the table below with notes on where they are, giving an understanding of operation of the system 1.

TABLE 1

| | Air/Gas/ |
|---|---|
| | Water |
| | Temperature |
| Part of System 1 | (° C.) |
| Ambient air inlet to main conduit 2 | 7 |
| Air flow from turbine 20 electronic controller waste heat, | 30 |
| delivered through the main conduit secondary inlet 5 | |
| Residual flue gas from third stage 25(c) of heat exchanger | 18 |
| (“HX”) to secondary inlet 26 of the main conduit 2 | |
| Flue gas from the turbine 20 into the HX first stage | 309 |
| Water into ASHP 50, from HX third stage | 20.6 |
| Air into cooler 8, from main conduit 2 | 12 |
| Air out of main conduit outlet 9 to ambient | 4 |
| Process hot water from first stage 25(a) of heat exchanger | 90 |
| Process hot water from second stage 25(b) of heat exchanger | 60 |
| Water from the ASHP 50 to the WSHP 60 | 22.4 |

The heat exchanger 25 is a three-stage heat exchanger with low pressure drop on the exhaust gas side, which provides heated process water from stage 25 (a) and 25 (b) at two temperature levels:
First stage, 90° C.;
Second Stage, 60° C.

The heat exchangers are comprised of a number of cassettes that are arranged both in series and in parallel to split the total water flows into two streams, thus reducing the flow through each stream, to manage port and channel pressure loss.

The heat exchanger 25 is shown in more detail in FIG. 2. Flue gas from the turbine enters via a conduit 27. The flue gas enters the first stage 25(a) at for example 309° C. The turbine flue gas is in the primary side of all three stages, the secondary side being water.

The turbine 20 receives gas fuel which with ambient air, is combusted to drive a turbine which in turn rotates a generator to generate electricity. The exhaust gas from the combustion exits after recuperation, at 309° C. and is progressively cooled to 18° C. in the three-stage water cooled heat exchanger system, HX 25.

The heating system delivers high temperature heat with greater efficiency than a boiler, and, without additional fuel consumption, will deliver electrical power with no additional environmental costs. This is achieved through the use of ambient air as a heat energy source. The system supplies its own controlled energy source for the heat pumps regardless of outside ambient air temperature. It can supply a source temperature 23° C. above ambient on to the evaporator 8.

In the example of FIGS. 1 and 2 there are two heat pumps, the ASHP 50 supplies part of the working energy source for the WSHP 60. A controller with digital data processors operates the heat pumps to maximise the combined overall efficiency by controlling the source temperature to each heat pump so that the combined heat pump cycle can deliver water at up to 80° C. from the WSHP 60 as an additional output to process.

With higher inlet water temperature, thermal output increases and net electrical output decreases. The heat pump capacities are selected so that the total power consumption, including pumps and other parasitic loads, do not exceed the power output of the turbine. The controller increases and decreases thermal and electrical outputs depending on ambient air temperature, and uses ambient air to increase output efficiency. It maintains efficiency at very low ambient (about −17° C.) by not using mixing ambient air and by pre-heating ambient air to the turbine (Mode 6).

The system generates electricity for its parasitic requirements on all operating modes, and the operating modes dictate surplus electrical output to process.

The system uses a three-compartment heat exchanger with three different temperature outputs, and it uses an air-to-air heat reclaim system which is temperature-controlled.

### Example (FIG. 1 and Table 1)

Flue gas exits the turbine (309° C., 1764 kg/h) enters the HX 25, and the gas is dispersed equally 882 kg/h per two heat exchangers streams in stage 25(a).

Stage 25(a), flue gas temperature is controlled by a temperature sensor Sensor 1 and a pump S-1 by controlling the speed of the pump S-1, the flue temperature having a set point of 94° C.

Flue gas exits stage 25(a) at 94° C. and enters stage two 25(b).

Stage 2, flue gas temperature is controlled by a temperature sensor Sensor-2 and a pump S-2 by controlling the speed. Flue temperature set point 54° C.

Flue gas second stage exit, 54° C. and enters stage three 25(c).

Stage 25(c), flue gas temperature is controlled in response to a temperature feed from a combined temperature and pressure sensor Sensor-3 and a pump S-3 is controlled by controlling the speed. Flue temperature set point is 18° C. All of the pumps S-1, S-2, and S-3 are VSD pumps.

Flue gas exits stage three 25(c) at 18° C. and enters the air in the main conduit 2, where it helps to increase the temperature in the main conduit to about 12° C. Hence the ambient air inlet at 7° C. flows through the conduit 2 and its temperature is increased by the hot air at 30° C. in the duct 5 from the turbine electronics and the flow in the duct 26 from the HX third stage at 18° C. This provides a flow to the evaporator 8, the refrigerant coil of which is in closed circuit with the ASHP 50, providing considerable energy to the ASHP while reducing the main conduit 2 air flow from 12° C. to 4° C. The VSD (variable speed drive) fan 7 sucks air (from turbine electronics and ambient air) in the main conduit 2 and blows blended air over the evaporator 8. Temperature of blended air is controlled by sensor S-4.

An anemometer and a temperature sensor Sensor-8 calculate available energy in air flow leaving 25(c), and this will modulate capacity of ASHP, WSHP and flow on pump S-3.

The speed of the pump P-1 is modulated to ensure that the water temperature at the temperature Sensor-5 inlet to the WSHP is 2K higher than water temperature at the temperature sensor Sensor-6.

If the temperature at the sensor Sensor-3>32° C., the system is disabled.

The sensor Sensor-3 is a combined pressure and temperature sensor. The controller is programmed to monitor by way of a feed from Sensor-3 the pressure in the flue gas heat exchanger 25. It is maintained at approximately 15 milliBar (mB) by control of the fan 8, and the preferred pressure range for the heat exchanger 25 is 5 mB to 20 mB. If it rises above the level of 20 mB the controller disables the overall system to prevent excessive fuel consumption. In one example, the fan 7 is varied if the Sensor-3 sensed pressure in the heat exchanger is in the range of 15 to 20 mB.

The setting of a modulating damper, that controls the amount of ambient air introduced, is-controlled by the output of a calculation involving the temperature sensor Sensor-4, anemometer and temperature sensor Sensor-7 and heat pump output. The calculation is used to determine the optimum mix of ambient air and condensing of exhaust gas. The controller calculates which mix is best to increase the overall efficiency.

In overall terms energy enters the system 1 as fuel to the turbine 20 and as ambient air into the inlet 7. The turbine is run with a lean mix, in one example 23:77 gas:air ratio. Energy is captured from the turbine control electronics and residual flue gas increase the energy in the air flowing through the main conduit 2, from the ambient inlet of 7° C. to 12° C. an entry to the evaporator 8. Energy from the evaporator 8 coil water energy from the HX third stage boost the inputs to the ASHP and WSHP, greatly increasing their efficiencies. There are three hot water outputs, 90° C. from the first stage of the HX, 60° C. form the second stage, and about 70° C. to 80° C. from the WSHP 60. For example, the WSHP 60 receives in one example inlet water at greater than 20° C. rather than about 8° C. which is typical.

FIGS. 3 to 8 illustrate various modes of operation, set out in detail below. In these examples and in the drawings all flows are per hour. Also, Stage 4 is provided by the main conduit 2, the fan 7, and the cooler 8.

### Mode 1 (FIG. 3)

| | | | |
|---|---|---|---|
| Flue gas flow | 18° | C. | 1,764 kg/h |
| Electronics air flow | 30° | C. | 1,664 kg/h |
| Ambient air flow | 7° | C. | 2,143 kg/h |
| Total air flow | | | 5,568 kg/h |
| Temperature to evaporator | 15° | C. | |
| Temperature from evaporator | 9° | C. | |
| Fuel in | 246 | kW | |
| Heat out | 226 | W | |
| Net electrical | 36 | kW | |
| Total kW out | 262 | kW | |

| | |
|---|---|
| FUE | 1.06 (F.U.E. (Fuel Utilisation Efficiency) |
| | is the ratio of fuel consumed to sum |
| | of electrical and thermal output. |

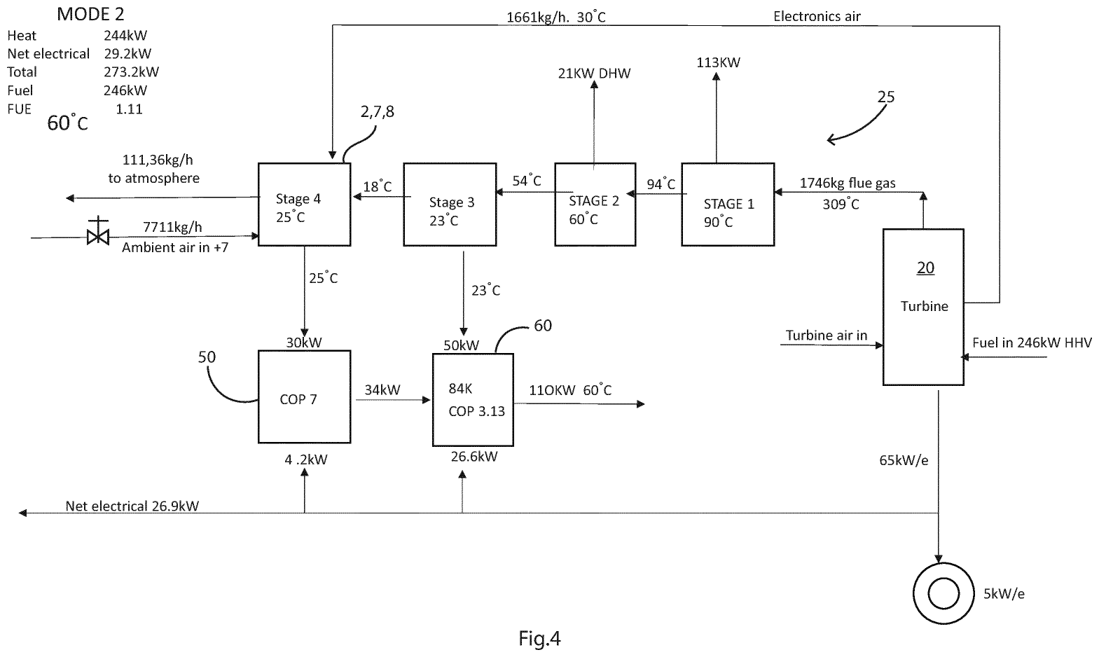

### Mode 2 (FIG. 4)

| | | | |
|---|---|---|---|
| Flue gas flow | 18° | C. | 1,764 kg/h |
| Electronics air flow | 30° | C. | 1,661 kg/h |
| Ambient air flow | 7° | C. | 7,711 kg/h |
| Total air flow | | | 11,136 kg/h |
| Temperature to evaporator | 12° | C. | |
| Temperature from evaporator | 4° | C. | |
| Fuel in. | 246 | kW | |
| Heat out | 244 | kW | |
| Net electrical | 29.2 | kW | |
| Total kW out | 273 | kW | |

| | |
|---|---|
| FUE. | 1.11 |

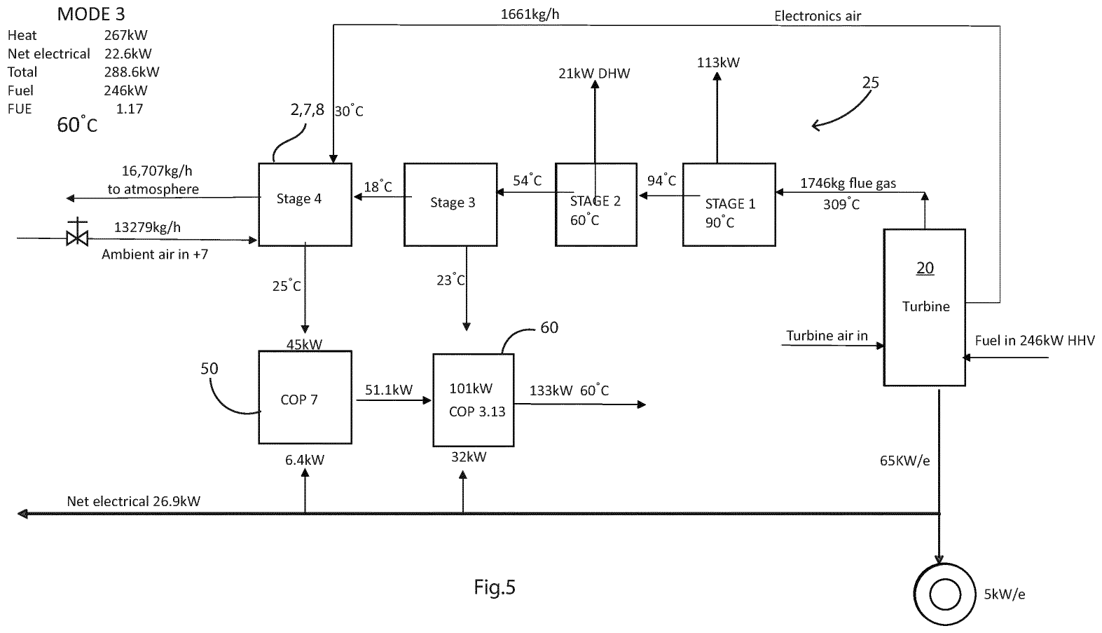

### Mode 3 (FIG. 5)

| | | | |
|---|---|---|---|
| Flue gas flow | 18° | C. | 1,764 kg/h |
| Electronics air flow | 30° | C. | 1,661 kg/h |
| Ambient air flow | 7° | C. | 13,279 kg/h |
| Total air flow | | | 16,797 kg/h |
| Temperature to evaporator | 10° | C. | |
| Temperature from evaporator | 2° | C. | |
| Fuel. In. | 246 | kW | |
| Heat out | 267 | kW | |
| Net electrical | 21 | kW | |
| Total kW out | 288 | kW | |

| | |
|---|---|
| FUE. | 1.17 |

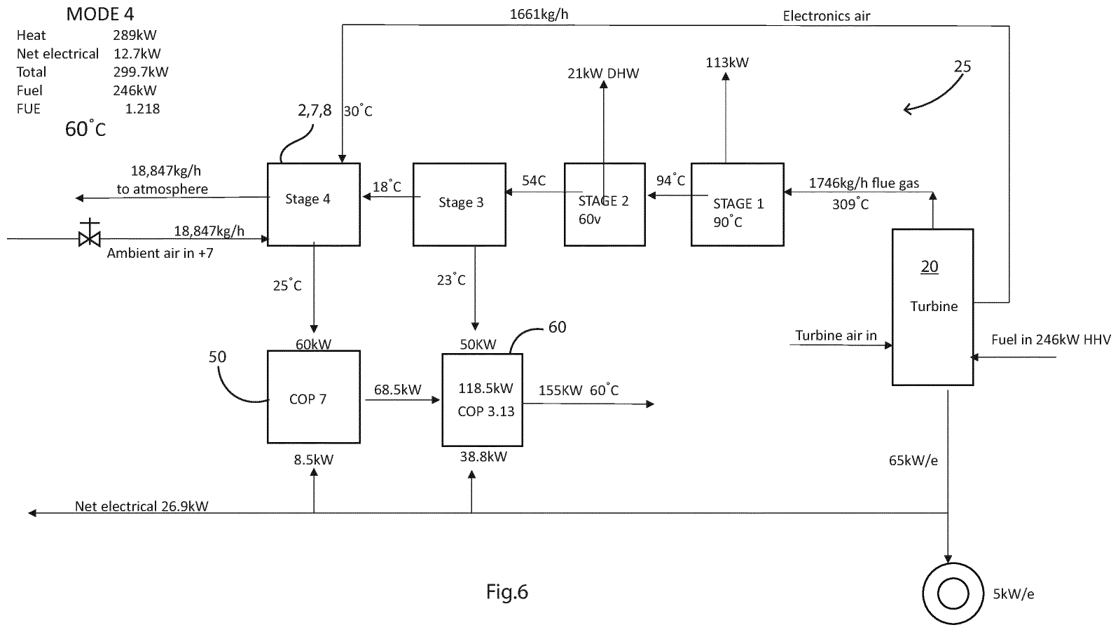

### Mode 4 (FIG. 6)

| | | | |
|---|---|---|---|
| Flue gas flow | 18° | C. | 1,764 kg/h |
| Electronics air flow | 30° | C. | 1,661 kg/h |
| Ambient air flow | 7° | C. | 18,847 kg/h |
| Total air flow | | | 22,272 kg/h |
| Temperature to evaporator | 9° | C. | |
| Temperature from evaporator | 1° | C. | |
| Fuel. In. | 246 | kW | |
| Heat out | 299 | kW | |
| Net electrical | 14 | kW | |
| Total kW out | 313 | kW | |

| | |
|---|---|
| FUE. | 1.27 |

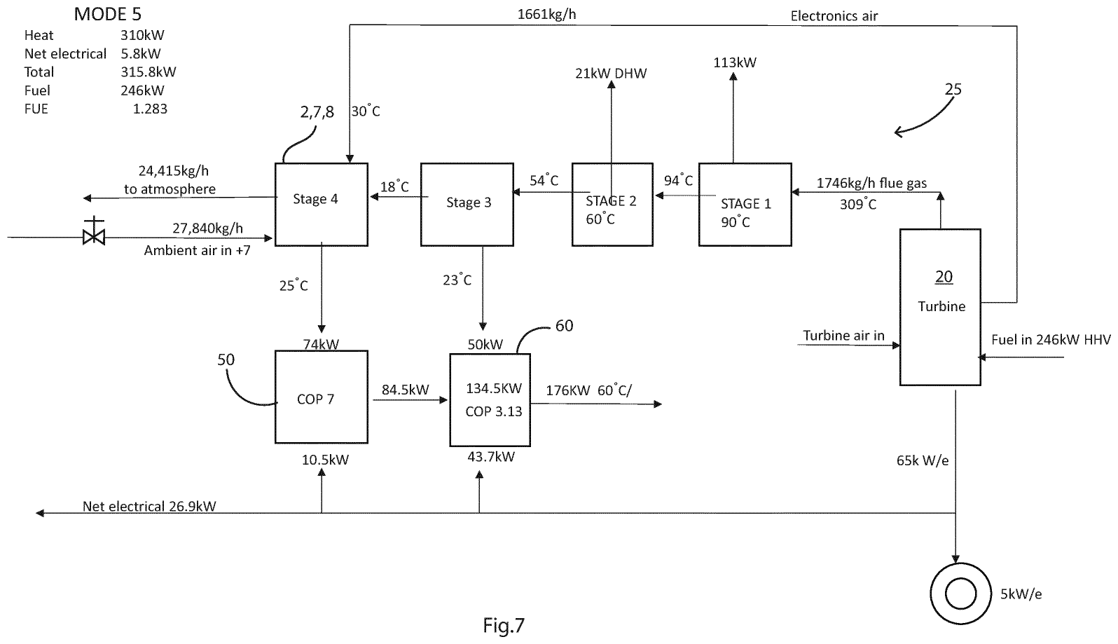

### Mode 5 (FIG. 7)

| | | | |
|---|---|---|---|
| Flue gas flow | 18° | C. | 1,764 kg/h |
| Electronics air flow | 30° | C. | 1,661 kg/h |
| Ambient air flow | 7° | C. | 24,315 kg/h |
| Total air flow | | | 27840 kg/h |
| Temperature to evaporator | 8° | C. | |
| Temperature from evaporator | 0° | C. | |
| Fuel. In. | 246 | kW | |
| Heat out | 310 | kW | |
| Net electrical | 5.8 | kW | |
| Total kW out | 315.8 | kW | |

| | |
|---|---|
| FUE. | 1.283 |

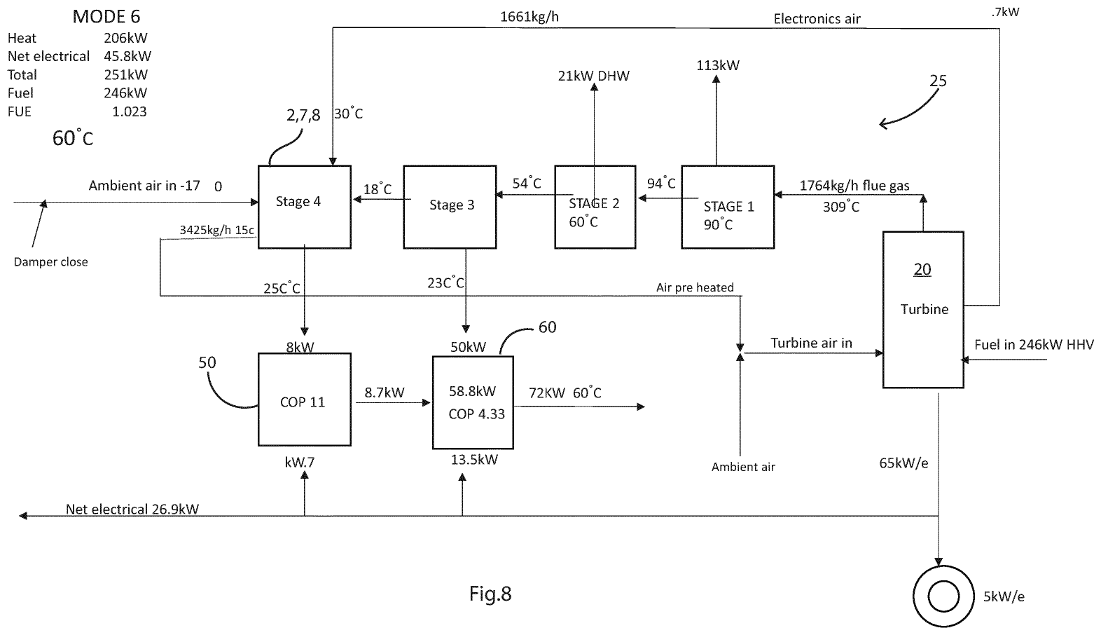

### Mode 6 (FIG. 8)

| | | | |
|---|---|---|---|
| Flue gas flow | 18° | C. | 1,764 kg/h |
| Electronics air flow | 30° | C. | 1,661 kg/h |
| Ambient air flow | −20° | C. | 0 |
| Total air. Flow | | | 3425 kg/h |
| Temperature to evaporator | 24° | C. | |
| Temperature from evaporator | 0° | C. | |
| Fuel. In. | 246 | kW | |
| Heat out | 246 | kW | |
| Net electrical | 36 | kW | |
| Total kW out | 286 | kW | |

| | |
|---|---|
| FUE. | 1.14 |

The system recovers latent heat energy through the condensation of the water vapour in the exhaust gas, without creating excessive back pressure on the turbine, while recovering energy to do useful work. It avoids the problem of a large surface being required to extract latent energy with one heat exchanger as it will cause back pressure on turbine and reduce electrical output, by reducing the volume flow through the heat exchanger. This is achieved by a number (in this example 16) of flue gas heat exchangers in parallel which divides the flow and halves the pressure drop.

Also, the system 1 achieves recovery of low temperature energy and delivery of high temperature energy by split heat recovery in multiple separate compartments and each compartment with its own delivered temperature set point with no temperature cross contamination.

Moreover, the system condenses flue gas, despite the fact that in general, condensing will not occur at exhaust gas temperatures greater than 54° C. This is primarily due to the use of a water source heat pump to cool the flue and extract the latent energy and use this energy to increase the efficiency of the WSHP. The temperature of the source to the WSHP can be controlled to allow the delivery of higher temperature water from the WSHP, whilst maintaining efficiency.

For example, with an exhaust gas flow of 1764 kg/h, with temperature in at 54° C., temperature out at 18° C. (36K):

{1,764 kg/h*1.027 kj/kg·K*36K/3600 s/h=18.1 kW (sensible heat)

{46 kg/h (water)*2,5009 kj/kg./3600 s/h=31.9 kW (latent heat)

The system moreover recovers residual waste heat from the flue gas, waste heat from the electronic circuits and ambient air, and elevates the blended air above the ambient air temperature. This temperature will increase efficiency on to evaporator coil 8 which increases the efficiency of the ASHP, in a controlled manner.

ASHP efficiency is maximized by recovery of free energy from the environment and latent heat, as set out in the following example:

| Flue gas flow | 1764 kg | 18° C. {1764*1027*18/3600000 = 9 kW} |
|---|---|---|
| Specific heat | 1027 J/kg | |
| Electronics air flow | 1661 kg | 30° C. {166I*30*1027/3600000 = 1 4K} |
| Ambient air | 24,415 kg | 7° C. {24,415*1027*7/3600000 = 48 kW} |
| Total kW | | {48 + 14 + 9 = 71}. |
| Total air flow | kg | 1764*1661 + 24315 = 27,840 |

Condensing 25 kg {21 kg*2500.9 jk/g*1000/3600000 = 17 kW
Temperature on to evaporator {88 kW*3600000/27,840/1027 = 8.9 C.} 11° C., greater than ambient

The invention is not limited to the embodiments described but may be varied in construction and detail. For example, the system may not have a WSHP, using only an ASHP to benefit from the elevation of temperature of the air in the main conduit. This would not be as efficient but would be a major improvement over the prior art. Also, the secondary inlets to the main conduit may be additionally or alternatively from other parts of the system, such as other electronic circuits or components having available heat. The air heat exchanger is preferably a cooler as described, with coolant transferring energy away from the main conduit air, but it could alternatively be an air-to-air heat exchanger for example.

1-35. (canceled)

36. A heating system comprising:
an electronic controller,
a turbine for burning a fuel to provide flue gas and electrical energy,
a flue gas heat exchanger or receiving the flue gas and using the flue gas to heat water,
a main conduit or receiving inlet air and gases from secondary inlets from within the system to elevate the temperature in the main conduit above ambient,
an air heat exchanger for recovering heat from the air flow of the main conduit, and
an air source heat pump ASHP to receive energy from the air heat exchanger.

37. The heating system as claimed in claim 36, further comprising a water source heat pump WSHP to receive a water feed at an elevated temperature from the ASHP, in which at least one stage of the flue gas heat exchanger and the WSHP provide process hot water.

38. The heating system as claimed in claim 36, wherein the flue gas heat exchanger heats water in a plurality of stages to provide a plurality of hot water process water outlets.

39. The heating system as claimed in claim 36, wherein the air heat exchanger comprises a cooler arranged to cool air from the main conduit for venting to atmosphere; and wherein the cooler comprises an evaporator coil cooler and it shares an evaporator coil with the ASHP to transfer energy to said ASHP.

40. The heating system as claimed in claim 36, wherein the air heat exchanger comprises a cooler arranged to cool air from the main conduit for venting to atmosphere; and wherein the cooler comprises an evaporator coil cooler and it shares an evaporator coil with the ASHP to transfer energy to said ASHP; and further comprising a water source heat pump WSHP to receive a water feed at an elevated temperature from the ASHP, in which at least one stage of the flue gas heat exchanger and the WSHP provide process hot water, and wherein recovered energy from the flue gas heat exchanger is provided to the WSHP.

41. The heating system as claimed in claim 36, wherein the air heat exchanger comprises a cooler arranged to cool air from the main conduit for venting to atmosphere; and wherein the cooler comprises an evaporator coil cooler and it shares an evaporator coil with the ASHP to transfer energy to said ASHP; and wherein the cooler and the ASHP are in an evaporator circuit, whereby the cooler delivers energy to the ASHP), the ASHP receives elevated-temperature water from the flue gas heat exchanger and delivers elevated temperature water to the WSHP, and the flue gas heat exchanger delivers elevated-temperature water to the WSHP.

42. The heating system as claimed in claim 36, wherein a main conduit first secondary inlet is adapted to provide heated air from control circuits of the turbine.

43. The heating system as claimed in claim 36, wherein a main conduit second secondary inlet is adapted to provide residual flue gas from the flue gas heat exchanger.

44. The heating system as claimed in claim 36, wherein a main conduit first secondary inlet is adapted to provide heated air from control circuits of the turbine, a main conduit second secondary inlet is adapted to provide residual flue gas from the flue gas heat exchanger; and wherein the first secondary inlet is arranged to provide turbine control circuit heated air upstream of the second secondary inlet.

45. The heating system as claimed in claim 36, wherein at least one stage of the heat exchanger comprises a plurality of circuits with the stage inlet flow being split for pressure reduction.

46. The heating system as claimed in claim 36, further comprising a water source heat pump WSHP to receive a water feed at an elevated temperature from the ASHP, in which at least one stage of the flue gas heat exchanger and the WSHP provide process hot water and wherein the WSHP provides process hot water as a product.

47. The heating system as claimed in claim 36, wherein the controller is adapted to recover latent heat energy without creating excessive back pressure on the turbine, while recovering energy to do useful work, thus avoiding deterioration of the electrical efficiency of the turbine.

48. The heating system as claimed in claim 36, further comprising a water source heat pump WSHP to receive a water feed at an elevated temperature from the ASHP, in which at least one stage of the flue gas heat exchanger and the WSHP provide process hot water; and wherein the controller is adapted to provide condensation of water vapour in the flue gas in the flue gas heat exchanger by the WSHP cooling the flue gas and extracting latent energy to increase the efficiency of the WSHP, the water vapour in the flue gas including the products of combustion and water vapour in incoming ambient air for combustion.

49. The heating system as claimed in claim 36, wherein the controller is adapted to cause the turbine to use a high air to fuel ratio, in excess of 30% air by weight yielding available heat from subsequent condensation.

50. The heating system as claimed in claim 36, wherein the main conduit comprises an outlet fan and the controller is configured to control said fan to control pressure in the flue gas heat exchanger in order to prevent excessive fuel consumption; and wherein the pressure in the flue gas heat exchanger is maintained in the range of 5 mB to 20 mB; and wherein the controller is configured to disable the system if the pressure in the flue gas heat exchange rises above 20 mB.

51. A method of operation of a heating system comprising:
an electronic controller,
a turbine,
a flue gas heat exchanger comprising a plurality of stages and being linked with a main conduit having at least one secondary inlet,
an air heat exchanger in said main conduit, and
an air source heat pump ASHP,
the method comprising the steps of:
the turbine burning a fuel to provide flue gas and electrical energy,
the flue gas heat exchanger receiving the flue gas and using the flue gas to heat water,
the main conduit receiving inlet air and gases from secondary inlets from within the system to elevate the temperature in the main conduit above ambient, and
the air heat exchanger recovering heat from air flow of the main conduit, and
the air source heat pump ASHP receiving energy from the air heat exchanger.

52. The method as claimed in claim 51, wherein the system further comprises a water source heat pump WSHP, and the method comprises said WSHP receiving a water feed at an elevated temperature from the ASHP, in which at least one stage of the flue gas heat exchanger and the WSHP provide process hot water.

53. The method as claimed in claim 51, wherein the flue gas heat exchanger heats water in the plurality of stages to provide a plurality of hot water process water outlets; and wherein the air heat exchanger comprises a cooler, and said cooler cools air from the main conduit for venting to atmosphere; and wherein the cooler comprises an evaporator coil cooler and it shares an evaporator coil with the ASHP, and the method comprises transferring energy to said ASHP via said coils.

54. The method as claimed in claim 51, wherein the flue gas heat exchanger heats water in the plurality of stages to provide a plurality of hot water process water outlets; and wherein the air heat exchanger comprises a cooler, and said cooler cools air from the main conduit for venting to atmosphere; and wherein the cooler comprises an evaporator coil cooler and it shares an evaporator coil with the ASHP, and the method comprises transferring energy to said ASHP via said coils; and wherein the system further comprises a water source heat pump WSHP, and the method comprises said WSHP receiving a water feed at an elevated temperature from the ASHP, in which at least one stage of the flue gas heat exchanger and the WSHP provide process hot water, and wherein recovered energy from the flue gas heat exchanger is provided to the WSHP.

55. The method as claimed in claim 51, wherein the system comprises a main conduit first secondary inlet, and said inlet provides heated air from control circuits of the turbine; and wherein the system comprises a main conduit second secondary inlet, and said inlet provides residual flue gas from the flue gas heat exchanger; and wherein the first secondary inlet provides heated air from control circuits of the turbine, the second secondary inlet provides residual flue gas from the flue gas heat exchanger; and the first secondary inlet provide turbines control circuit heated air upstream of the second secondary inlet.

56. The method as claimed in claim 51, wherein at least one stage of the heat exchanger comprises a plurality of circuits, and the method comprises splitting stage inlet flow for pressure reduction; and wherein the WSHP provides process hot water as a product.

57. The method as claimed in any of claim 51, comprising recovering latent heat energy without creating excessive back pressure on the turbine, while recovering energy to do useful work, thus avoiding deterioration of the electrical efficiency of the turbine; and the method comprising providing condensation of water vapour in the flue gas in the flue gas heat exchanger by the WSHP cooling the flue gas and extracting latent energy to increase the efficiency of the WSHP, the water vapour in the flue gas including the products of combustion and water vapour in incoming ambient air for combustion.

58. The method as claimed in claim 51, wherein the turbine uses a high air to fuel ratio, in excess of 30% air by weight yielding available heat from subsequent condensation; and wherein the main conduit comprises an outlet fan and said fan is controlled to control back pressure on the flue gas heat exchanger in order to prevent excessive fuel consumption; and wherein the pressure in the flue gas heat exchanger is maintained in the range of 5 mB to 20 mB; and wherein the system is disabled if the pressure in the flue gas heat exchange rises above 20 mB.
